(19) United States
(12) Patent Application Publication
(10) Pub. No.: US 2024/0062262 A1
(43) Pub. Date: Feb. 22, 2024

(54) Systems and Methods for a Zero-Trust Index Mutual Aid

(71) Applicant: STATE FARM MUTUAL AUTOMOBILE INSURANCE COMPANY, Bloomington, IL (US)

(72) Inventors: Ryan Michael Gross, Normal, IL (US); M Eric Riley, SR., Heyworth, IL (US); Jody Ann Thoele, Bloomington, IL (US); Jordan Jeffers, Normal, IL (US); Shawn Renee Harbaugh, Normal, IL (US); Rick Lovings, Normal, IL (US); Joann C. Yant, Bloomington, IL (US); Jenny L. Jacobs, Normal, IL (US)

(21) Appl. No.: 17/962,803

(22) Filed: Oct. 10, 2022

Related U.S. Application Data
(60) Provisional application No. 63/398,741, filed on Aug. 17, 2022.

(51) Int. Cl. G06Q 30/06; H04L 9/00

(52) U.S. Cl. CPC G06Q 30/0615; H04L 9/50

(57) ABSTRACT

Systems and methods are described for facilitating a zero-trust index mutual aid on a distributed ledger. The method may include: (1) receiving weather data at the distributed ledger; (2) detecting, based at least upon the weather data, that a trigger for a parametric event is met for a first subset of a plurality of users; (3) retrieving, responsive to the detecting, payment from a second subset of the plurality of users in accordance with a smart contract stored on the distributed ledger; (4) allocating the payment from the second subset of the plurality of users into respective allocated payments in accordance with the smart contract; and (5) causing the first subset of the plurality of users to receive the respective allocated payments in accordance with the smart contract.

### CROSS REFERENCE TO RELATED APPLICATIONS

This application claims the benefit of (1) U.S. Provisional Patent Application No. 63/398,741, entitled “Systems and Methods for a Zero-Trust Index Mutual Aid,” filed Aug. 17, 2022. U.S. Provisional Patent Application No. 63/398,741 is hereby expressly incorporated by reference herein in its entirety.

### FIELD OF THE DISCLOSURE

Systems and methods are disclosed for using a distributed ledger for implementing a zero-trust index mutual aid for parametric events, confirming the trigger of a parametric event, and/or reducing fraud by preventing gaming of the system.

### BACKGROUND

Weather events and other, similar parametric events may cause damages to the livelihoods for individuals, such as farmers. As such, to protect the interests of individuals for whom parametric events may cause damages, multiple users may collectively implement a mutual aid system. However, traditional methods for maintaining such a mutual aid system may be vulnerable to fraud, may lack accessibility to key information, may require trust and trustworthiness of the participants, and may be subject to the biases of those individuals maintaining the system. Conventional techniques may have other drawbacks as well.

### SUMMARY

The present embodiments relate to systems and methods for securely, neutrally, and efficiently implementing a zero-trust index mutual aid for parametric events. In certain embodiments, weather and/or other data may be stored on a distributed ledger, a trigger, trigger event, and/or parametric event may be determined from processor analysis of the weather and/or other data, and as a result, one or more payments may be made, such in accordance with one or more smart contracts. In general, the triggers, trigger events, and/or parametric events discussed herein may relate to weather events, and/or weather more generally in specific areas or fields, that may impact negatively (or positively) crops or crop yields (such as lack of rain, heavy down pours, high winds, tornados, hail, early frost or snow in the fall, late frost or snow in the spring, etc.). Machine learning algorithms may be utilized to verify or enhance the accuracy of the trigger or parametric event determination.

In one aspect, a computer-implemented method for facilitating a zero-trust index mutual aid on a distributed ledger may be provided. The method may be implemented via one or more local or remote processors, servers, sensors, transceivers, memory units, and/or other electronic or electrical components. The method may include: (1) receiving, by one or more processors, weather data at the distributed ledger; (2) detecting, by the one or more processors and based at least upon the weather data, that a trigger for a parametric event is met for a first subset of a plurality of users; (3) retrieving, by the one or more processors and responsive to the detecting, payment from a second subset of the plurality of users in accordance with a smart contract stored on the distributed ledger; (4) allocating, by the one or more processors, the payment from the second subset of the plurality of users into respective allocated payments in accordance with the smart contract; and/or (5) causing, by the one or more processors, the first subset of the plurality of users to receive an indication of the respective allocated payments in accordance with the smart contract. The detecting may include detecting that the trigger for the parametric event is met using a machine learning algorithm, and the method may additionally include receiving an indication whether the machine learning algorithm accurately detected that the trigger for the parametric event is met; and/or training the machine learning algorithm based upon at least the weather data and the indication. The method may include additional, fewer, or alternative actions, including those discussed elsewhere herein.

For instance, in some embodiments, the method may include (i) transmitting, to the second subset of the plurality users, details of the parametric event; (ii) receiving, from at least some of the second subset of the plurality users, an indication of whether a moral hazard is associated with the parametric event; and/or (iii) authenticating, based at least upon the indication, the parametric event. The retrieving payment may be responsive to the authenticating and the detecting. The indication of whether a moral hazard may be associated with the parametric event may include a consensus from a majority of the second subset of the plurality of users. Similarly, the method may further include transmitting the weather data to a third party; and receiving, from the third party, an assessment of risk for each of the plurality users; and the authenticating may further be based at least upon the assessment of risk.

In some embodiments, the receiving the weather data may further include receiving the weather data from at least one of: (i) a distributed weather oracle, (ii) a synthetic aperture radar, or (iii) user comment databases.

In certain embodiments, the weather data may include unstructured weather data and the method may further include (a) extracting the unstructured weather data; and/or (b) analyzing the unstructured weather data using natural language processing (NLP).

In another aspect, a computing system for facilitating a zero-trust index mutual aid on a distributed ledger may be provided. The computing device may include: a memory storing a set of computer-executable instructions; and one or more processors (and/or associated sensors and transceivers) interfacing with the memory, and configured to execute the computer-executable instructions to cause the one or more processors to: (1) receive weather data at the distributed ledger; (2) detect, based at least upon the weather data, that a trigger for a parametric event is met for a first subset of a plurality of users; (3) retrieve, responsive to the detecting, payment from a second subset of the plurality of users in accordance with a smart contract stored on the distributed ledger; (4) allocate the payment from the second subset of the plurality of users into respective allocated payments in accordance with the smart contract; and/or (5) cause the first subset of the plurality of users to receive an indication of the respective allocated payments in accordance with the smart contract. The detecting may include detecting that the trigger for the parametric event is met using a machine learning algorithm, and the memory may further store instructions that, when executed by the one or more processors, cause the computing system to: receive an indication whether the machine learning algorithm accurately detected that the trigger for the parametric event is met; and/or train the machine learning algorithm based upon at least the weather data and the indication. The computing device may include additional, less, or alternate functionality, including that discussed elsewhere herein.

For instance, in some embodiments, the memory may further store instructions that, when executed by the one or more processors, cause the computing system to: (i) transmit, to the second subset of the plurality users, details of the parametric event; (ii) receive, from at least some of the second subset of the plurality users, an indication of whether a moral hazard is associated with the parametric event; and/or (iii) authenticate, based at least upon the indication, the parametric event, and the retrieving payment may be responsive to the authenticating and the detecting. The indication of whether a moral hazard is associated with the parametric event may include a consensus from a majority of the second subset of the plurality of users. Similarly, the memory may further store instructions that, when executed by the one or more processors, cause the computing system to: (a) transmit the weather data to a third party; and/or (b) receive, from the third party, an assessment of risk for each of the plurality users; wherein the authenticating is further based at least upon the assessment of risk.

In some embodiments, the receiving the weather data may further include receiving the weather data from at least one of: (i) a distributed weather oracle, (ii) a synthetic aperture radar, or (iii) user comment databases.

In certain embodiments, the weather data may include unstructured weather data and the memory may further store instructions that, when executed by the one or more processors, cause the computing system to: (i) extract the unstructured weather data; and/or (ii) analyze the unstructured weather data using natural language processing (NLP).

In another aspect, a tangible, non-transitory computer-readable medium storing instructions for facilitating a zero-trust index mutual aid on a distributed ledger may be provided. The instructions may be executed via one or more local or remote processors, servers, sensors, transceivers, memory units, and/or other electronic or electrical components. The instructions may include instructions that, when executed by one or more processors of a computing device, cause the computing device to: (1) receive weather data at the distributed ledger; (2) detect, based at least upon the weather data, that a trigger for a parametric event is met for a first subset of a plurality of users; (3) retrieve, responsive to the detecting, payment from a second subset of the plurality of users in accordance with a smart contract stored on the distributed ledger; (4) allocate the payment from the second subset of the plurality of users into respective allocated payments in accordance with the smart contract; and/or (5) cause the first subset of the plurality of users to receive an indication of the respective allocated payments in accordance with the smart contract. The detecting may include detecting that the trigger for the parametric event is met using a machine learning algorithm, and the tangible, non-transitory computer-readable medium may further store instructions that, when executed by the one or more processors, cause the computing device to: (a) receive an indication whether the machine learning algorithm accurately detected that the trigger for the parametric event is met; and/or (b) train the machine learning algorithm based upon at least the weather data and the indication. The tangible, non-transitory computer-readable medium may store instructions with additional, less, or alternate functionality, including those discussed elsewhere herein.

For instance, in some embodiments, the tangible, non-transitory computer-readable medium may further store instructions that, when executed by the one or more processors, cause the computing device to: (i) transmit, to the second subset of the plurality users, details of the parametric event; (ii) receive, from at least some of the second subset of the plurality users, an indication of whether a moral hazard is associated with the parametric event; and/or (iii) authenticate, based at least upon the indication, the parametric event; wherein the retrieving payment is responsive to the authenticating and the detecting. The indication of whether a moral hazard is associated with the parametric event may include a consensus from a majority of the second subset of the plurality of users. Similarly, the tangible, non-transitory computer-readable medium may further store instructions that, when executed by the one or more processors, cause the computing device to: (a) transmit the weather data to a third party; and/or (b) receive, from the third party, an assessment of risk for each of the plurality users; wherein the authenticating is further based at least upon the assessment of risk.

In some embodiments, the receiving the weather data may further comprise receiving the weather data from at least one of: (i) a distributed weather oracle, (ii) a synthetic aperture radar, or (iii) user comment databases.

In certain embodiments, the weather data may include unstructured weather data and the tangible, non-transitory computer-readable medium may further store instructions that, when executed by the one or more processors, cause the computing device to: extract the unstructured weather data; and/or analyze the unstructured weather data using natural language processing (NLP).

This summary is provided to introduce a selection of concepts in a simplified form that are further described in the Detailed Descriptions. This summary is not intended to identify key features or essential features of the claimed subject matter, nor is it intended to be used to limit the scope of the claimed subject matter.

Advantages will become more apparent to those of ordinary skill in the art from the following description of the preferred aspects, which have been shown and described by way of illustration. As will be realized, the present aspects may be capable of other and different aspects, and their details are capable of modification in various respects. Accordingly, the drawings and description are to be regarded as illustrative in nature and not as restrictive.

### BRIEF DESCRIPTION OF THE DRAWINGS

FIG. 1 depicts an exemplary computing system that facilitates a zero-trust index mutual aid on a distributed ledger, implementing a zero-trust index mutual aid for parametric events, confirming the trigger of a parametric event, and/or reducing fraud by preventing gaming of the system.

FIG. 2 depicts an exemplary distributed ledger system for recording transactions and executing smart contracts related to parametric event(s), in accordance with one aspect of the present disclosure.

FIG. 3 depicts exemplary validating network nodes and an exemplary transaction flow on a distributed ledger network related to parametric event(s), in accordance with one aspect of the present disclosure.

FIG. 4 depicts exemplary components of a network node on a distributed ledger network related to parametric event(s), in accordance with one aspect of the present disclosure.

FIG. 5A depicts an exemplary transaction representing payment for a parametric event generated by a payee device communicatively coupled to network.

FIG. 5B depicts an exemplary smart contract state in a distributed ledger network for retrieving and generating payment for a subset of affected users.

FIG. 6 depicts a flow diagram representing an exemplary computer-implemented method for facilitating a zero-trust index mutual aid on a distributed ledger.

FIG. 7 depicts a flow diagram representing an exemplary computer-implemented method for authenticating a parametric event based upon an indication from users and/or a neutral risk assessment.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

Techniques, systems, apparatuses, components, devices, and methods are disclosed for, inter alia, utilizing a distributed ledger, or blockchain, to generate and/or maintain a zero-trust index mutual aid. For example, a distributed ledger may be maintained by nodes, such as computing devices associated with weather oracles, federal weather organizations, state weather organizations, amateur weather groups, regulatory organizations, insurance companies, farmers, farming companies, and/or other organizations involved in evaluating a level of risk, sensing or predicting the weather, and/or performing events or actions that risk damage by potential weather events, such as farming. The nodes may receive transactions broadcasted to a distributed ledger network from weather units within weather sensing devices communicatively coupled to the network.

More specifically, the weather data may include data regarding temperature, weather patterns, weather pattern predictions, local weather, distant weather, general weather, temporally recent weather, historical weather, climate information, recent changes to climate, long-term changes to climate, sensor data, amateur weather data, professional weather data, natural language comments on weather, etc.

In further embodiments, the computing system may receive additional data, such as parametric event data. In some such embodiments, the parametric event data may include trigger data, coverage data, payout data, location data for a location that may be affected by the parametric event, property data for property that may be affected by the parametric event, user data for a user that may be affected by the parametric event, etc.

In some embodiments, the parametric event may be a particular weather event (e.g., a rainfall of greater than 2 inches in an hour, a hail storm, a tornado, high winds, heavy down pour, etc.), a general weather event (e.g., a spate of unseasonably cold weather for a week; prolonged drought, lack of rain during a certain time period (such as during July or August, or during pollination), etc.), a general status event (e.g., a failure of a field of crops, or below average yields for one or more fields), another type of parametric event (e.g., a chemical composition change in soil contents), etc. Similarly, depending on the embodiment, the trigger event may be a particular measurable threshold (e.g., 2 inches of rainfall in an hour or less, hail for 15 minutes, high winds for 20 minutes, etc.), a particular calculated threshold (e.g., a 50% chance of failure for a field, 20% estimated crop yield loss (such as due to lack of rain during and after pollination), an indicative flag (e.g., detecting that snow has fallen or a frost has occurred during the early or late growing season—damaging the crop, leading to crop loss, or ending the growing season prematurely), or any other similar trigger, including those discussed elsewhere herein.

The computing system may receive weather data at a distributed ledger that includes a zero-trust index mutual aid. The computing system may then use the weather data to detect whether a trigger for a parametric event (or a trigger event) is met. In some embodiments, the computing system may detect the trigger for the parametric event is met for a first subset of a plurality of users. In further embodiments, the computing system then may retrieve payment from a second subset of the plurality of users. Depending on the embodiment, the computing system may retrieve the payment in accordance with a smart contract stored on the distributed ledger.

The computing system may then allocate the payment into respective allocated payments in accordance with the smart contract. In some implementations, the computing system may divide the payment by the number of users to receive the payout. In further implementations, the computing system may allocate the payment according to the smart contract and allocate different percentages and/or amounts to different users. In some such implementations in which a single user receives the payout, the computing system may divide the payment by the number of users (i.e., one), or may allocate the payment such that a majority (e.g., 99%) of the payout goes to the user and a nominal fee is allocated to various services for transferring the funds, maintaining the transfer process, etc. The computing system may then cause the users to receive an indication of the allocated payment at a computing device.

Depending on the embodiment, the computing system may retrieve the weather data from the blockchain, directly from a node on the blockchain, etc. The computing system may then determine and/or verify the details during a time period in which the parametric event allegedly occurred. In some embodiments, the computing system may authenticate the parametric event based upon an indication of whether a moral hazard occurred (e.g., from other participants on the ledger) and/or based upon an assessment of risk from a third party (e.g., a non-user entity on the blockchain).

Still further, the computing system may utilize distributed ledgers to execute smart contracts, described in more detail below. An organization involved in generating or paying out a settlement quote may deploy a smart contract to the distributed ledger to generate a payment based upon the weather data. In some embodiments, the smart contract may require members of the zero-trust index mutual aid to provide payment to a central fund.

The computing system implementing the zero-trust index mutual aid may be an improvement over traditional methods for sharing potential loss at least through improvements by improving security and reducing the potential for fraud. Similarly, the computing system implementing the zero-trust index mutual aid may increase transparency and security through the use of a distributed ledger as described herein. Moreover, the computing system implementing the zero-trust index mutual aid may receive novel forms of data, such as unstructured data, and extract usable data for analytics, thereby further improving the accuracy and range of usable data. The computing system implementing the zero-trust index mutual aid may also use machine learning algorithms to more accurately analyze the data in question. Further, the computing system implementing the zero-trust mutual aid may use nested machine learning algorithms to further improve the functionality of the system by normalizing an input so that the computing system may analyze the inputs collectively (e.g., in the case of unstructured weather data) and/or by improving the verification of an event used in performing the calculation for the assessment of risk.

By utilizing distributed ledgers and, in some scenarios, smart contracts to record weather data and generates a zero-trust index mutual aid on a distributed ledger, implements a zero-trust index mutual aid for parametric events, confirms the trigger of a parametric event, and/or authenticates the parametric event, a system may provide a trusted, secure, and immutable record of the weather data. The secure, immutable, and trustless nature of distributed ledgers is particularly important to reduce fraud in a largely automated system by preventing gaming of the system. In particular, providing an open environment and automatically confirming events and/or querying experts ensures that a user may not game the system. Due to the automatic nature of the reporting and the difficulty of changing the recorded weather data in the distributed ledgers, interested entities do not have to trust that the data is reliable.

As an example, a farmer may join a zero-trust index mutual aid hosted on a distributed ledger and enter into a smart contract with other members of the mutual aid with protection for crops being planted, with a trigger being a predetermined amount of rain within a certain time period. The zero-trust index mutual aid may determine that the trigger is met when the system receives an indication from a weather oracle that sufficient rain falls to cause flooding, killing the majority of the crops. As such, the zero-trust index mutual aid further allocates the money for the farmer according to the smart contract by retrieving funds from the other members of the mutual aid and appropriately allocating the money to the farmer before alerting the farmer of the payout available.

A blockchain (also referred to herein as a distributed ledger or a shared ledger) is a storage mechanism for data, events, transactions, etc. that several participants maintain. More specifically, a distributed ledger is a way of achieving a distributed consensus on the validity or invalidity of information in the distributed ledger. In other words, the blockchain may provide a decentralized trust to participants and observers. As opposed to relying on a central authority, a blockchain is a decentralized database in which each node of a peer-to-peer network maintains and validates a transactional record of changes to the ledger. The distributed ledger is comprised of groupings of transactions organized together into a “block,” and ordered sequentially (hence the term “blockchain”). While the distributed ledgers discussed herein are referred to in the context of a blockchain, this is merely one example of a distributed ledger. Distributed ledgers may also include a tangle, a block lattice, or other directed acyclic graph (DAG). In any event, nodes may join and leave the blockchain network over time and may obtain blocks that were propagated while the node was gone from peer nodes. Nodes may maintain addresses of other nodes and exchange addresses of known nodes with one another to facilitate the propagation of new information across the network in a decentralized, peer-to-peer manner.

The nodes that share the ledger form what is referred to herein as the distributed ledger network, distributed weather data ledger, weather ledger, etc. The nodes in the distributed ledger network may validate changes to the blockchain (e.g., when a new transaction and/or block is created) according to a set of consensus rules. The consensus rules depend on the information being tracked by the blockchain and may include rules regarding the chain itself. For example, a consensus rule may include that the originator of a change should supply a proof-of-identity such that only approved entities may originate changes to the chain. A consensus rule may require that blocks and transactions adhere to format requirement and supply certain meta information regarding the change (e.g., blocks must be below a size limit, transactions must include a number of fields, etc.). Consensus rules may include a mechanism to determine the order in which new blocks are added to the chain (e.g., through a proof-of-work system, proof-of-stake system, proof-of-burn system, etc.).

Additions to the blockchain that satisfy the consensus rules may be propagated from nodes that have validated the addition to other nodes of which the validating node is aware. If all the nodes that receive a change to the blockchain validate the new block, then the distributed ledger may reflect the new change as stored on all nodes, and it may be said that distributed consensus has been reached with respect to the new block and the information contained therein. Validating nodes that receive any change that does not satisfy the consensus may disregard the change and do not propagate the change to other nodes. Accordingly, unlike a traditional system which uses a central authority, a single party cannot unilaterally alter the distributed ledger unless the single party can do so in a way that satisfies the consensus rules. The inability to modify past transactions leads to blockchains being generally described as trusted, secure, and immutable. Therefore, blockchains may remove potential attack vectors for tampering with the weather and/or parametric event data, such as those inherent in a centralized database maintained by an organization involved in determining the level of risk for a user.

The validation activities of nodes applying consensus rules on a blockchain network may take various forms. In one embodiment, the blockchain may appear as a shared spreadsheet that tracks data such as the weather and/or parametric data. In another embodiment, the validating nodes execute code contained in “smart contracts” and distributed consensus may be expressed as the network nodes agreeing on the output of the executed code.

A smart contract is a computer protocol that enables the automatic execution and/or enforcement of an agreement between different parties. In particular, the smart contract may be computer code located at a particular address on the blockchain. In some cases, the smart contract may run automatically in response to a participant in the blockchain sending funds (e.g., a cryptocurrency such as bitcoin, ether, or other digital/virtual currency) to the address where the smart contract is stored. Additionally, smart contracts may maintain a balance of the amount of funds stored at the address. In some scenarios when the balance reaches zero, the smart contract may no longer be operational.

The smart contract may include one or more trigger conditions, that, when satisfied, may correspond to one or more actions. For some smart contracts, the system may determine to perform action(s) based upon one or more decision conditions. In some instances, the system routes data streams to the smart contract so that the smart contract may detect that a trigger condition has occurred and/or analyze a decision condition.

The computing system may deploy blockchains in a public, decentralized, and permissionless manner, meaning that any party may view the shared ledger, submit new information to be added to the ledger, or join the network as a validating node. Other blockchains may be private (e.g., permissioned ledgers) and keep chain data private among a group of entities authorized to participate in the blockchain network.

The present embodiments relate to computing systems and computer-implemented methods for using a blockchain to record and manage information related to weather data and/or parametric event data. The blockchain may be either a public or permissioned ledger.

Exemplary Distributed Ledger for Calculating Risk, Detecting an Event Trigger, and/or Authenticating a Parametric Event

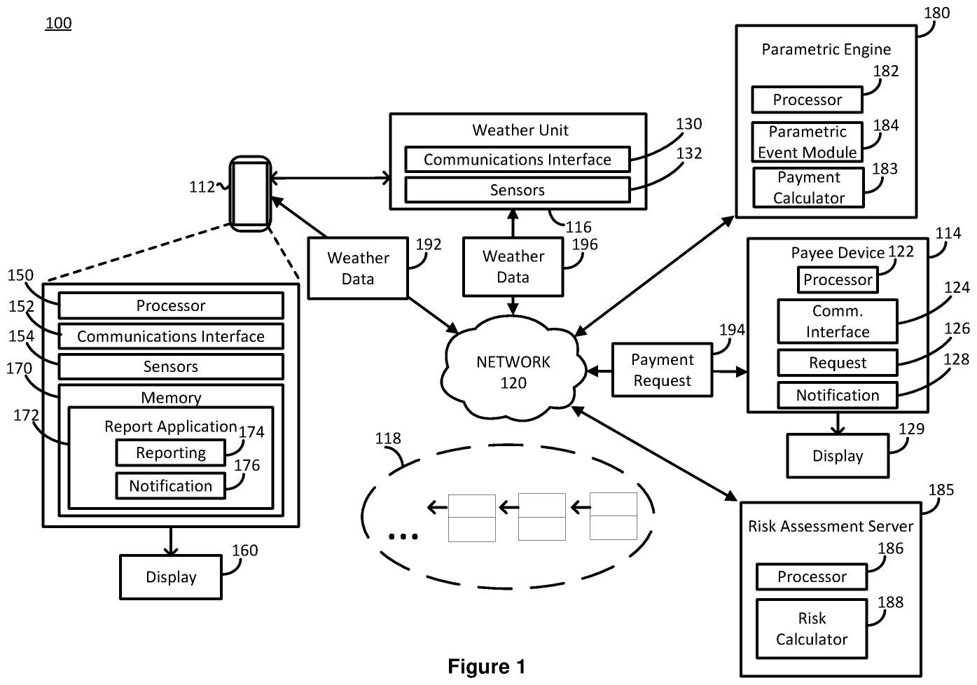

FIG. 1 depicts an exemplary computing system 100 for generating transactions based upon weather data for a user, updating a distributed ledger, facilitating a payment for affected users, and/or calculating a level of risk using weather data and/or parametric event data from the distributed ledger in accordance with various aspects of the present disclosure. An entity (e.g., payee device 114), such as a user, may suffer a loss associated with a parametric event and subsequently wish to receive reimbursement for the loss. Additionally, a weather unit (e.g., weather unit 116) and/or one or more mobile devices (e.g., mobile device 112) may detect and store weather data associated with the parametric event. The computing system 100 may include a blockchain 118 accessible by network participants via a network 120 (e.g., a private or public packet switched network) as described in more detail herein.

The weather unit 116 may transmit weather data in transactions 196 to the blockchain 118. Further, though FIG. 1 only depicts weather data in transactions 196, the weather unit 116 may further include only structured weather data, or transmit unstructured data in transactions 196, alongside, in place of, or separately from the structured weather data. Depending on the embodiment, the weather unit 116 may be or include weather sensors, a distributed weather oracle, one or more smart devices configured to gather weather data, a weather organization database, etc. In embodiments in which the weather data is or includes unstructured weather data, the weather unit 116 may be a chatroom, website, blog, or other similar collection of natural language weather data. In such implementations, the computing system 100 and/or a parametric engine 180 in the computing system 100 may use optical character recognition, (OCR), natural language processing (NLP), and/or similar techniques to analyze the unstructured weather data. Additionally or alternatively, one or more mobile devices (e.g., mobile device 112) communicatively coupled to the weather unit 116 may transmit structured and/or unstructured weather data in transactions 192 to the blockchain 118.

The weather unit 116 may include a processor, a set of one or several sensors 132, and/or a communication interface 130. The set of sensors 132 may include, for example, a barometer, a temperature and humidity (T&H) sensor, a wind speed sensor, a wind direction sensor, a rain gauge, a solar radiation sensor, a sunlight sensor, a UV sensor, a noise sensor, a rain/snow sensor, a negative ion sensor, an evaporation sensor, a soil moisture sensor, a soil nitrogen/phosphorus/potassium (NPK) sensor, a soil pH sensor, a leaf moisture sensor, etc. In further embodiments, the weather unit 116 may be a database, website, data log, etc. and connects to and/or receives data from external sensors instead. As such, although FIG. 1 depicts the set of sensors 132 inside the weather unit 116, it is noted that the sensors 132 need not be integral components of the weather unit 116.

The communication interface 130 may allow the weather unit 116 to communicate with the mobile device 112. The communication interface 130 may support wired or wireless communications, such as USB, Bluetooth, Wi-Fi Direct, Near Field Communication (NFC), etc. The communication interface 130 may allow the weather unit 116 to communicate with various content providers, servers, the blockchain network, etc., via a wireless communication network such as a fifth-, fourth-, or third-generation cellular network (5G, 4G, or 3G, respectively), a Wi-Fi network (802.11 standards), a WiMAX network, a wide area network (WAN), a local area network (LAN), etc. The processor may operate to format messages transmitted between the weather unit 116 and the mobile device 112, process data from the sensors 132, transmit transactions to the blockchain network, etc.

Mobile device 112 may be associated with (e.g., in the possession of, configured to provide secure access to, etc.) a particular user, who may be a user of the zero-trust index mutual aid or may be a user who records weather-related data, such as a storm chaser. Mobile device 112 may be a personal computing device of that user, such as a smartphone, a tablet, smart glasses, or any other suitable device or combination of devices (e.g., a smart watch plus a smartphone) with wireless communication capability. In the embodiment of FIG. 1, mobile device 112 may include a processor 150, a communications interface 152, sensors 154, a memory 170, and a display 160. Processor 150 may include any suitable number of processors and/or processor types. Processor 150 may include one or more CPUs and one or more graphics processing units (GPUs), for example. Generally, processor 150 may be configured to execute software instructions stored in memory 170. Memory 170 may include one or more persistent memories (e.g., a hard drive and/or solid state memory) and may store one or more applications, including report application 172.

The mobile device 112 may be communicatively coupled to the weather unit 116. For example, the mobile device 112 and the weather unit 116 may communicate via USB, Bluetooth, Wi-Fi Direct, Near Field Communication (NFC), etc. For example, the weather unit 116 may send weather data, parametric event data, or other sensor data in the weather unit 116 via communications interface 130 and the mobile device 112 may receive the weather data, parametric event data, or other sensor data via communications interface 152.

In other embodiments, mobile device 112 may obtain the weather data from the weather unit 116 from sensors 154 within the mobile device 112. Further still, mobile device 112 may obtain the weather data via a user interaction with a display 160 of the mobile device 112. For example, a user may input information regarding weather data and/or a parametric event at the display 160. Reporting unit 174 may be configured to prompt a user to send temperature information and/or other weather data at the display 160. The mobile device 112 may then generate a transaction that may include the weather data and may transmit the transaction 192 to the blockchain network via communications interface 152.

In some embodiments, the report application 172 may be communicatively coupled to a weather and/or parametric event application. In such embodiments, the mobile device 112 may obtain the weather data and/or parametric event data via stored data in the application or via a notification 176 in the report application 172 granting the report application 172 access to the application data.

In some embodiments, the weather data may be interpretations of raw sensor data, such as detecting a parametric event when a sensor detects a threshold amount of rainfall. In further embodiments, the weather data may be raw, unstructured weather data, such as comments by a storm chaser or a weather-related blog. In such embodiments, the computing system 100 may detect a parametric event and/or a trigger for a parametric event after analyzing the unstructured data, such as by using NLP at a parametric engine 180.

The sensors, computing devices, and/or components of the computing system 100 may collect and transmit weather to the blockchain network in real-time (e.g., as the weather data is collected) or at least near real-time at each time interval in which the computing system 100 collects weather data. In other embodiments, sensors, computing devices, and/or components of the computing system 100 may collect a set of weather data at several time intervals over a time period (e.g., a day), and the weather unit 116 and/or mobile device 112 may generate and transmit a transaction which may include the set of weather data collected over the time period. Also, in some embodiments, the weather unit 116 and/or mobile device 112 may generate and transmit transactions periodically (e.g., every minute, every hour, every day), where each transaction may include a different set of weather data collected over the most recent time period. In other embodiments, the weather unit 116 and/or mobile device 112 may generate and transmit transactions as the weather unit 116 and/or mobile device 112 receive new weather data.

In further embodiments, the weather unit 116 may include a trusted party that may collect and transmit the weather data, such as a weather oracle. The weather oracles may be devices connected to the internet that record and/or receive information about the physical environment around them and/or devices connected to sensors, such as a weather unit 116, a mobile device 112, sensors 132, a weather forecasting server, an amateur storm chasing server, etc. The data may be packaged into a transaction, such as transaction 192 or 196. The data from the weather oracle may include a transaction ID, an originator (identified by a cryptographic proof-of-identity and/or a unique oracle ID), a data type (such as unstructured or structured data), and a cryptographic hash of the data. In another embodiment, the evidence is not stored as a cryptographic hash, but is directly accessible by an observer or other network participant.

Next, the weather unit 116 may generate a transaction 196 including a representation of the weather data wherein the transaction 196 is stored in the blockchain 118. When entities broadcast transactions to the blockchain 118, a proof-of-identity of the entity broadcasting the transaction may accompany the transaction. In one embodiment, the entity broadcasting the transactions may include a cryptographic proof-of-identity in transactions sent to the blockchain. For example, each of the entities 112 and 116 may own private cryptographic keys that are associated with public cryptographic keys known to belong to the entity (e.g., public cryptographic keys associated with each of the entities may be published by a trusted third party or proven to other network participants, etc.).

An entity wishing to broadcast a transaction to the blockchain 118 may sign a cryptographic message in the transaction with the entity's private cryptographic key to prove the identity of the entity broadcasting the transaction. In this way, other network participants may receive cryptographic proof that the participating entity originated the information contained in the broadcast transaction. Accordingly, generating the transaction 196 may include obtaining identity data for the weather unit 116, obtaining identity data for the mobile device 112 in the weather unit 116, and augmenting the transaction 196 with the identity data for the weather unit 116 and/or the mobile device 112. The transaction 196 may include the weather data or a cryptographic hash value corresponding to the weather data.

Next, the weather unit 116 may transmit, for example via communications interface 130, the transaction 196 to at least one other participant in a distributed ledger network of participants maintaining the distributed ledger. Additionally or alternatively, mobile device 112 may obtain weather data, generate a transaction 192 including a representation of the weather data wherein the transaction 192 is stored in the blockchain 118, and transmit the transaction 192 to at least one other participant in a distributed ledger network of participants. The transaction 192 may include the weather data or a cryptographic hash value corresponding to the weather data. Further still, a third party device, such as a third party server (not illustrated), may obtain weather data (e.g., from the network 120, weather unit 116, and/or the mobile device 112), generate a transaction including a representation of the weather data wherein the transaction is stored in the blockchain 118, and transmit the transaction to at least one other participant in a distributed ledger network of participants. The transaction 192 may include the weather data or a cryptographic hash value corresponding to the weather data.

In some embodiments, in addition to transmitting the weather data to at least one other participant in a distributed ledger network of participants, the mobile device 112 or the weather unit 116 may transmit the weather data to a parametric engine 180 and/or a risk assessment server 185. The parametric engine 180 may include a processor 182 and a memory that stores various applications for execution by the processor 182. For example, a parametric event module 184 may perform various operations associated with analyzing the parametric event. For example, the parametric event module 184 may detect that a trigger for a parametric event is met based upon the weather data. In some such embodiments, the parametric event module 184 may use a machine learning algorithm as described herein to detect whether a trigger is met. For example, the machine learning algorithm may determine that a threshold for precipitation is met, a predetermined amount of damage has occurred, a soil composition has changed, an environment parameter for particular plants has changed, etc. In further embodiments, the parametric event module 184 may execute a smart contract to retrieve payment from a subset of users of the zero-trust index mutual aid and/or cause the payment calculator 183 to subsequently allocate the payment from the subset of users in accordance with the smart contract. Although FIG. 1 illustrates both the parametric event module 184 and the payment calculator 183 on the same parametric engine 180, it will be understood that the parametric event module 184 and the payment calculator 183 may operate on different servers.

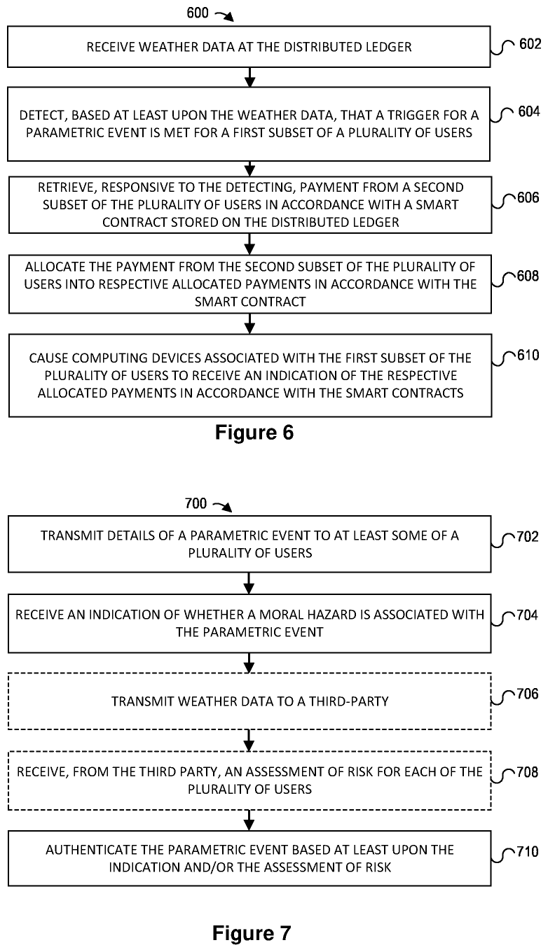

Similarly, the risk assessment server 185 may include a processor 186 and a memory that stores various applications for execution by the processor 186, such as risk calculator 188. The risk calculator 188 may obtain weather data and/or parametric event data for a user to analyze and calculate a risk for a user during a particular time period, as described in more detail below with regard to FIG. 7. Depending on the embodiment, the risk assessment server 185 may be a third-party not affiliated with any of the users of the zero-trust index mutual aid, such as an insurance company, underwriter, organizational body, etc. In some such implementations, the third-party further maintains at least part of the zero-trust index mutual aid for the users.

In some embodiments, a payee device 114 as described above may transmit a request 194 to the parametric engine 180 for verification and/or calculation of a payment. In response to the request, the parametric engine 180 may verify the weather data and/or details of the parametric event. In further implementations, the parametric engine 180 and/or the payee device 114 transmits an indication to the risk assessment server 185 to calculate an assessment of risk (e.g., a likelihood of loss) to the user and compare the parametric event details and/or weather data to the assessment of risk to authenticate the loss. In further implementations, the parametric engine 180 and/or the payee device 114 similarly transmits details regarding the weather data and/or the parametric event to other users to verify the event. The parametric engine 180 may then transmit the verification to the payee device 114 for presentation on the display 129. Although the payee device 114 and the mobile device 112 are depicted separate in FIG. 1, it will be understood that the payee device 114 and the mobile device 112 may be the same device and/or may be associated with the same user.

In some embodiments, the blockchain 118 may include cryptographic hash values corresponding to the set of weather data used to generate each output. To verify the authenticity of the set of weather data and/or parametric event data used, the parametric engine 180 may compare the set of weather data and/or parametric event data included in the report to the corresponding cryptographic hash values in the blockchain 118. If the set of weather data and/or parametric event data used to generate the respective output does not match with the corresponding cryptographic hash values in the blockchain 118, the parametric engine 180 may determine that an outside party has tampered with the weather data and/or parametric event data. Otherwise, if the set of weather data and/or parametric event data used to generate the report matches with the corresponding cryptographic hash values in the blockchain 118, the parametric engine 180 may determine that the weather data and/or parametric event data is valid and that the quote, calculation, and/or verification is an accurate output.

In some embodiments, a mobile device 112 may stream the weather data to a node of the blockchain 118 and/or the network 120 in real or near-real time. For example, the mobile device and/or a reporting application 172 on the mobile device 112 may update the node of the blockchain 118 and/or the network 120 whenever a new event occurs, as described above. In further embodiments, the mobile device 112 may receive confirmations of updated information and may notify the user that the mobile device 112 has updated the blockchain 118 and/or network 120.

The computing system 100 may determine weather data, trigger events, assessment of risk, and/or parametric event data at the parametric engine 180, payee device 114, and/or risk assessment server 185 based upon one or more machine learning models. The machine learning model(s) may be trained based upon (i) a plurality of sets of weather data having a known rate of reaching a trigger event and/or trigger threshold, (ii) sets of weather data and confirmations from users as to whether the trigger event occurred, and/or (iii) a plurality of sets of weather data and corresponding assessment of risk. The machine learning model may use the weather data and/or parametric data to generate the appropriate trigger event detection, assessment of risk, etc.

In other embodiments, as an alternative to the parametric engine 180 detecting the trigger or authenticating the event, and/or the risk assessment server 185 generating the assessment of risk, the computing system 100 may deploy a smart contract to the blockchain 118 and/or network 120 to perform the operations. Any participant in the blockchain network may deploy the smart contract, and the smart contract may expose methods and data to other participants in the blockchain network. The smart contract may obtain weather data for a user and may detect the trigger, authenticate the event, and/or generate the assessment of risk. Some of the data in the smart contract state may be private data that may only be altered by calling a method of the smart contract, or only altered by authorized blockchain participants. In one embodiment, the computing system 100 may alter the smart contract state by broadcasting a transaction to the distributed ledger network. If the broadcasted transaction satisfies consensus rules, network validators may include the transaction in a block.

Inclusion in the blockchain of a transaction sending data to the smart contract may cause validating nodes to update a state database for the smart contract. Therefore, the validating nodes may allow network participants access to a rich state mechanism to manage the analysis of the weather data and/or the parametric event data, and ultimately to detect the trigger, authenticate the event, and/or generate the assessment of risk. In this embodiment, transmitting a transaction (e.g., transactions 196 or 192) may include transmitting the transaction to an address that stores the smart contract on the blockchain 118.

In response to transmitting a transaction to the blockchain network, a validating node may add the transaction (e.g., transactions 196 or 192) to a block of transactions. Adding the transaction 196 and/or 192 to a block of transactions may include solving a cryptographic puzzle based upon the block of transactions, adding the solution to the cryptographic puzzle to the block of transactions, and transmitting the block of transactions to at least one other participant in the distributed ledger network.

In some embodiments, to cryptographically link blocks and transactions together, each block in the blockchain 118 may organize transactions into a Merkle Tree. In a Merkle Tree, the respective block hashes each transaction according to a cryptographic hashing algorithm (e.g., SHA-256) and then combines the resulting output hash with the hash of another transaction. Then the respective block hashes the combined result according to the cryptographic hashing algorithm. The block then combines the output with the hash of two other transactions and this process is repeated until all of the transactions in the block are combined and hashed to generate a Merkle root that is used in the header for a block. If any single transaction in the block is tampered with, a different Merkle root would be generated since the Merkle root is a combination of the hashes of all of the transactions in the block.

In other words, the computing system 100 may hash the transactions using a cryptographic hash algorithm, such as the algorithms discussed above, and the computing system 100 may store the hash of each transaction in the tree. As the computing system 100 constructs the tree, the block may hash together the hash of each adjacent node at the same level to create a new node that exists at a higher level in the tree. Therefore, the node at the top of the tree or Merkle root, may be dependent upon the hash of each transaction stored below in the tree. Each transaction may include a set of data. The set of data may include identifying data for the transaction, and transaction data identifying the nature of the transaction and what the transaction entails (e.g., input and output addresses, a transaction value, a document hash value, a timestamp, a transaction fee value, etc.).

To verify that a block is valid, a node may compare the Merkle root of the block to the Merkle root for the same block included in other nodes' copies of the blockchain. Thus, the Merkle root may be proof of the transactions included in the block and proof that the contents of the block have not been tampered with if the Merkle root is the same in each node's copy of the block.

In one embodiment, documents stored “on” a blockchain are documents that have been hashed according to a cryptographic hashing algorithm (e.g., SHA-256) and the resulting output hash has been included in a transaction in a block that has been accepted by the network nodes as satisfying the consensus rules of the blockchain. As such, the documents may be later verified or validated by comparing the hash of the documents to the hash stored on the blockchain. For example, if a set of documents results in a SHA-256 hash recorded on a blockchain on a certain date, then the blockchain may provide cryptographic proof that the documents existed as of that date.

In some embodiments, the computing system 100 may store a document on a blockchain by broadcasting a transaction including a hash of the document to the network, which a component of the computing system 100 may include in a block if the transaction satisfies all of the consensus rules of the network. In some embodiments, the blockchain may be a permissioned ledger, meaning only authorized network participants may broadcast transactions. In other embodiments, only some authorized network participants may make certain transactions. For example, the weather unit 116 and/or the mobile device 112 may upload the weather data to the blockchain 118. Only a cryptographic hash of the data may be included in the blockchain 118 such that the blockchain may verify the data even if a party off-chain obtains the data.

Validating network nodes may verify that the signed transaction or signed message was signed by the private cryptographic key corresponding to the published public cryptographic key. In at least one embodiment, the blockchain network may apply a valid proof-of-identity as a consensus rule. As such, the network may reject any transaction attempting to add new weather data and/or parametric event data to the blockchain without a cryptographic proof-of-identity matching an identity authorized to add new weather data and/or parametric event data as non-compliant with the consensus rule. Each weather unit 116 and/or mobile device 112 may be assigned a public key/private key pair which is identified in the blockchain network as corresponding to the weather unit 116 and/or mobile device 112. If the validating network nodes receive a transaction regarding weather data and/or parametric event data that is not from an authorized weather unit 116 and/or mobile device 112, the validating network nodes may reject the transaction.

The mobile device 112 and the weather unit 116 may be associated with the same user. Weather unit 116 may be communicatively coupled to payee device 114 via a network 120. Network 120 may be a single communication network, or may include multiple communication networks of one or more types (e.g., one or more wired and/or wireless local area networks (LANs), and/or one or more wired and/or wireless wide area networks (WANs) such as the internet). In some implementations, the payee device 114 may connect to the network 120 via a communications interface 124 much like mobile device 112. Similarly to mobile device 112, the payee device 114 may include processors 122 by which the payee device 114 may receive requests and transmit notifications 128, as well as a display 129.

While FIG. 1 shows only one mobile device 112, it is understood that many different mobile devices (of different users), each similar to mobile device 112, may be in remote communication with network 120. Additionally, while FIG. 1 shows only one weather unit 116, it is understood that many different entity locations, each similar to weather unit 116, may be in remote communication with network 120. Further, while FIG. 1 shows only one payee device 114, it is understood that many different devices, each similar to payee device 114, may be in remote communication with network 120.

It will be understood that the above disclosure is one example and does not necessarily describe every possible implementation. As such, it will be further understood that alternate embodiments may include fewer, alternate, and/or additional steps or elements.

### Exemplary Machine Learning

As described herein, the computing system 100 may generate a zero-trust index mutual aid on a distributed ledger, implement a zero-trust index mutual aid for parametric events, confirm the trigger of a parametric event, and/or reduce fraud by preventing gaming of the system from the weather data and/or parametric event data using a machine learning model for data evaluation. The machine learning model may be trained based upon a plurality of sets of weather data and/or parametric event data, and corresponding output data and/or determinations. In some embodiments, the machine learning model may use some of the output data to generate additional output data and/or determinations.

Machine learning techniques have been developed that allow statistical analysis of large quantities of data. Such machine learning techniques may be used to automatically identify relevant variables (i.e., variables having statistical significance or a sufficient degree of explanatory power) from data sets. This may include identifying relevant variables or estimating the effect of such variables that indicate actual observations in the data set. This may also include identifying latent variables not directly observed in the data, viz. variables inferred from the observed data points.

In some embodiments, the methods and systems described herein may use machine learning techniques to identify and estimate the effects of observed or latent variables such as weather, temperature, seasonal hazards and/or changes, local fauna, local flora, air quality, pollen, landscape, bodies of water, local population density, local classification (e.g., urban, rural, suburban, city, town, village, etc.), proximity to a fire station, presence of nearby fire hydrants, adherence to respective best practices, history of parametric events, historical weather data, appliances, smart devices, water consumption, power consumption, security, type of claim, cost of claim, cause of the claim, confirmation of fault, liability amount paid out, property damage paid out, freeform data (need to understand that from a data perspective, so needs other processing), coverage is paid, catastrophe, bodily injury, repair costs, estimated values for items damaged, prior damage, claim subrogation status, location of loss, date of loss, time of loss, date the claim was reported, etc.

Some embodiments described herein may include automated machine learning to determine assessment of risk (e.g., likelihood of loss), identify relevant risk factors, evaluate weather data and/or parametric event data, identify environmental risk factors, identify locale-based risk factors, identify property risk factors, analyze unstructured weather data, calculate a likelihood of reaching a trigger threshold for a parametric event, determine whether to offer updated coverage (such as crop insurance coverage), authenticate a parametric event from the weather data and/or parametric event data, and/or perform other functionality as described elsewhere herein.

Although the methods described elsewhere herein may not directly mention machine learning techniques, such methods may be read to include such machine learning for any determination or processing of data that may be accomplished using such techniques. In some embodiments, such machine-learning techniques may be implemented automatically upon occurrence of certain events or upon certain conditions being met. Use of machine learning techniques, as described herein, may begin with training a machine learning program, or such techniques may begin with a previously trained machine learning program.

A processor or a processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data (such as location, online activity, mobile device data, weather unit data, and/or updated sensor data) in order to facilitate making predictions for subsequent user data. Models may be created based upon example inputs of data in order to make valid and reliable predictions for novel inputs.

Additionally or alternatively, the machine learning programs may be trained by inputting sample data sets or certain data into the programs, such as mobile device, server, or weather unit sensor and/or control signal data, and other data discussed herein. The machine learning programs may utilize deep learning algorithms that are primarily focused on pattern recognition, and may be trained after processing multiple examples. The machine learning programs may include Bayesian program learning (BPL), voice recognition and synthesis, image or object recognition, optical character recognition, and/or natural language processing, either individually or in combination. The machine learning programs may also include natural language processing, semantic analysis, automatic reasoning, and/or machine learning.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct or a preferred output. In unsupervised machine learning, the processing element may be required to find its own structure in unlabeled example inputs. In one embodiment, machine learning techniques may be used to extract the control signals generated by computer systems or sensors, and under what conditions those control signals were generated.

The machine learning programs may be trained with smart device-mounted, home-mounted, and/or mobile device-mounted sensor data to identify certain weather data, such as analyzing unstructured weather data to identify and/or determine environmental data, location data, parametric event data, historical data, structured weather data, and/or other such potentially relevant data.

After training, machine learning programs (or information generated by such machine learning programs) may be used to evaluate additional data. Such data may be related to publically accessible data. Other data may be related to privately-held data, such as insurance and/or claims information related to the property and/or items associated with the property. The trained machine learning programs (or programs utilizing models, parameters, or other data produced through the training process) may then be used for determining, assessing, analyzing, predicting, estimating, evaluating, or otherwise processing new data not included in the training data. Such trained machine learning programs may, therefore, be used to perform part or all of the analytical functions of the methods described elsewhere herein.

### Exemplary Validating Nodes in a Distributed Ledger System for a Zero-Trust Index Mutual Aid

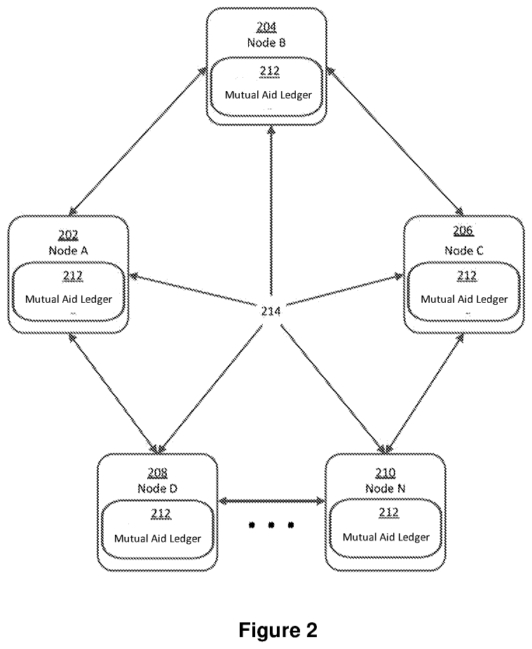

FIG. 2 depicts an exemplary distributed ledger system 200 for generating transactions based upon weather data for a parametric event, updating a distributed ledger, detecting a parametric event trigger, authenticating a parametric event, and/or calculating an assessment of risk using weather data from the distributed ledger in accordance with various aspects of the present disclosure. The system 200 may include a distributed mutual aid ledger 212 and a plurality of nodes 202, 204, 206, 208, and 210. Each node maintains a copy of the mutual aid ledger 212. As changes are made to the mutual aid ledger 212, each node receiving the change via network 214 may update the respective copy of the distributed mutual aid ledger 212 stored on the node. In some embodiments, the network 214 may be or may include the blockchain 118 of FIG. 1. A consensus mechanism may be used by the nodes 202-210 in the distributed ledger system 200 to decide whether to the nodes 202-210 may make received changes to the mutual aid ledger 212.

Each node in the system therefore may have a copy of the mutual aid ledger 212, which is identical to every other copy of the mutual aid ledger 212 stored by the other nodes. The distributed ledger system 200 is more robust than a central authority database system because of the distributed ledger's decentralized nature. As such, there is no single point of failure on the distributed ledger system 200 as there would be in a centralized system.

It will be understood that the above disclosure is one example and does not necessarily describe every possible implementation. As such, it will be further understood that alternate embodiments may include fewer, alternate, and/or additional steps or elements.

### Exemplary Transaction Flow & Block Propagation Flow

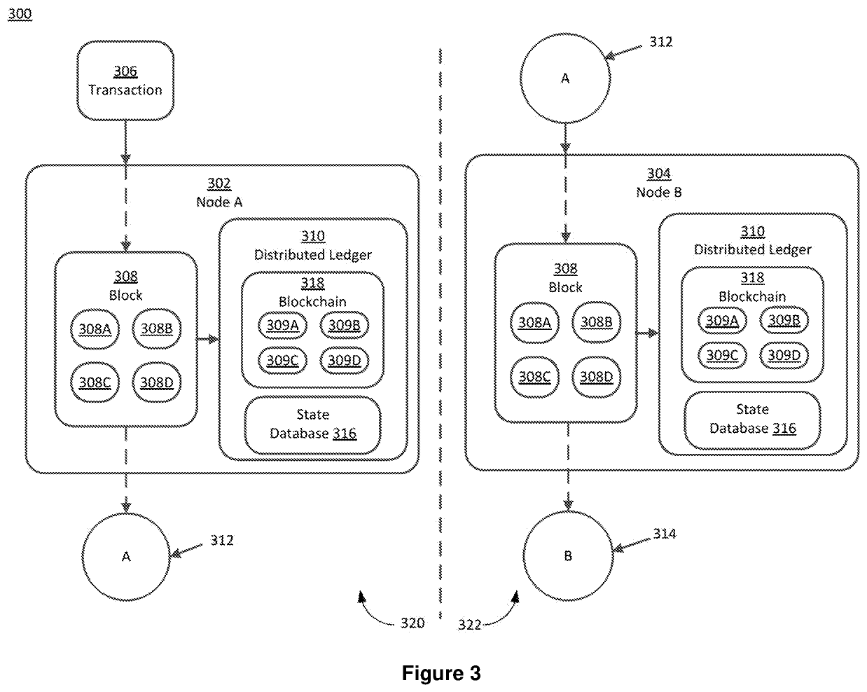

FIG. 3 depicts exemplary validating network nodes and an exemplary transaction flow 300 on a distributed ledger network for generating transactions based upon weather data for a parametric event, updating a distributed ledger, detecting a parametric event trigger, authenticating a parametric event, and/or calculating an assessment of risk using weather data from the distributed ledger in accordance with various aspects of the present disclosure. FIG. 3 may include two time frames 320 and 322 represented by the left and right sides of the dotted line, respectively, Node A 302 and Node B 304, a set of transactions 308A-308D, a set of blocks of transactions 309A-309D, a distributed ledger 310, a state database 316, and a blockchain 318.

The block propagation flow 300 may begin with Node A 302 receiving transaction 306 at time 320. When Node A 302 confirms that transaction 306 is valid, the Node A 302 may add the transaction 306 to a newly generated block 308. As part of adding the transaction 306 to block 308, Node A 302 may solve a cryptographic puzzle and may include the solution in the newly generated block 308 as proof of the work done to generate the block 308. In other embodiments, Node A 302 may add the transaction 306 to a pool of transactions until a sufficient number of transactions in the pool exist to form a block 308. Node A 302 may then transmit the newly created block 308 to the network at 312. Before or after propagating the block 308, Node A 302 may add the block 308 to its copy of the blockchain 318.

The transactions 309A-309D may include updates to a state database 316. The state database 316 may contain current values of variables created by smart contracts deployed on the blockchain 318. Validated blocks such as block 308 may include transactions affecting state variables in state database 316. At time 322 Node B 304 may receive the newly created block 308 via the network at 312. Node B 304 may verify that the block of transactions 308 is valid by checking the solution to the cryptographic puzzle provided in the block 308. If the solution is accurate then Node B 304 may add the block 308 to its blockchain 318 and make any updates to the state database 316 as required by the transactions in block 308. Node B 304 may then transmit the block 308 to the rest of the network at 314.

It will be understood that the above disclosure is one example and does not necessarily describe every possible implementation. As such, it will be further understood that alternate embodiments may include fewer, alternate, and/or additional steps or elements.

### Exemplary Node

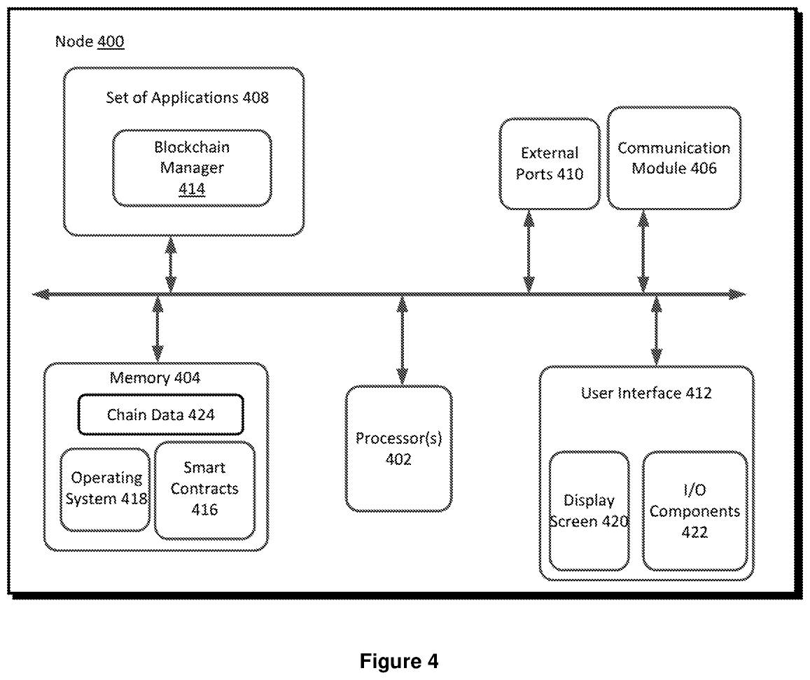

FIG. 4 depicts exemplary components of a network node 400 on a distributed ledger network for generating transactions based upon weather data for a parametric event, updating a distributed ledger, detecting a parametric event trigger, authenticating a parametric event, and/or calculating an assessment of risk using weather data from the distributed ledger in accordance with various aspects of the present disclosure. Node 400 is capable of performing the functionality disclosed herein. Node 400 may include at least one processor 402, memory 404, a communication module 406, a set of applications 408, external ports 410, user interface 412, a blockchain manager 414, smart contracts 416, operating system 418, a display screen 420, and input/output components 422. In some embodiments, the node 400 may generate a new block of transactions or may broadcast transactions to other network nodes by using the blockchain manager 414. Similarly, the node 400 may use the blockchain manager 414 in conjunction with the smart contracts 416 stored in memory 404 to execute the functionality disclosed herein. The memory 404 may further include chain data 424 including, for example, a state database of the blockchain for storing state of smart contracts deployed thereon.

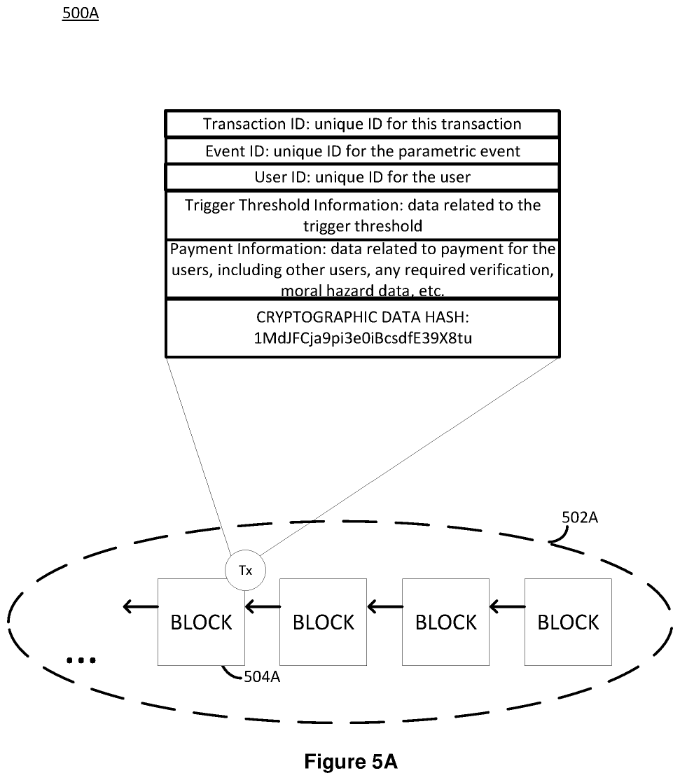

In other embodiments, the smart contracts 416 may operate independently of the blockchain manager 414 or other applications. In some embodiments, node 400 may not have a blockchain manager 414, or smart contracts 416 stored at the node. The components of the node 400 are described in more detail above with regard to FIG. 1 and below with regard to FIGS. 5A and 5B.

The node 400, as part of a decentralized ledger computing system 100, or another decentralized or centralized network, may be used as part of systems that interact with and/or manipulate data and transactions associated with the weather data aggregation process, the parametric event trigger detection process, the risk calculation process, and/or the parametric event authentication process.

It will be understood that the above disclosure is one example and does not necessarily describe every possible implementation. As such, it will be further understood that alternate embodiments may include fewer, alternate, and/or additional steps or elements.

### Exemplary Weather Data Transaction

FIG. 5A depicts an exemplary transaction 500A on a distributed ledger network for updating a distributed ledger with weather data in accordance with one aspect of the present disclosure. A weather unit 116 or a mobile device 112 communicatively coupled to the weather unit 116 may generate the transaction 500A. When the weather unit 116 and/or mobile device 112 obtain a set of weather data from the sensors 132 or from the mobile device 112 over a particular time period (e.g., one minute, 10 minutes, one hour, etc.), the weather unit 116 and/or mobile device 112 may then broadcast the transaction 500A to blockchain 502A to be included in a block, such as block 504A.

The transaction 500A may include various information regarding the weather data. For example, the transaction 500A may include a transaction ID and an originator such as the mobile device 112 (identified by a cryptographic proof-of-identity). The transaction 500A may also include identification information for the weather unit 116, and the weather data including an indication of a time in which the weather data was generated. The weather data may also include trigger threshold information, such as a particular trigger threshold, a trigger type, rules for the trigger, etc. In further embodiments, the transaction 500A may additionally or alternatively include payment information related to payment for the users. In some implementations, the payment information may include an identifier or reference to a particular smart contract related to the trigger or parametric event in question, other users included in the smart contract, required verification, moral hazard data as discussed herein, etc. Furthermore, the transaction 500A may include a cryptographic hash corresponding to the weather and/or parametric event data. In another embodiment, the weather and/or parametric event data is not stored as a cryptographic hash, but may be directly accessible in block 504A by an observer or other network participant.

It will be understood that the above disclosure is one example and does not necessarily describe every possible implementation. As such, it will be further understood that alternate embodiments may include fewer, alternate, and/or additional steps or elements.

### Exemplary Smart Contract State

As described above, a participant in the distributed ledger network such as a computing device associated with federal weather organizations, state weather organizations, amateur weather groups, regulatory organizations, insurance companies, farmers, farming companies, and/or other organizations involved in evaluating a level of risk, sensing or predicting the weather, and/or performing events or actions that risk damage by potential weather events, such as farming, may deploy smart contracts to the distributed ledger. In some embodiments, the organization involved in evaluating a level of risk, sensing or predicting the weather, and/or performing events or actions that risk damage by potential weather events may deploy copies of smart contracts for each user to a different address on the blockchain. Accordingly, a computing device may transmit a request to the address for the smart contract corresponding to the user in question.

FIG. 5B depicts an exemplary smart contract state 500B in a distributed ledger network for detecting a parametric event trigger, authenticating a parametric event, and/or calculating an assessment of risk in accordance with one aspect of the present disclosure. FIG. 5B may include a blockchain 502B, a block of transactions 504B, and a parametric smart contract state 506B. A participant in the blockchain network may deploy a smart contract to establish a contract state 506B for a particular level of risk and/or settlement quote request. The deployed smart contract may expose methods and data to other participants in the blockchain network. Some of the data in the smart contract state may be private data that may only be altered by calling a method of the smart contract or only altered by authorized blockchain participants.

One way of altering the parametric smart contract state 506B is to broadcast a transaction to the blockchain network. If the broadcast transaction satisfies consensus rules, network validators may include the transaction in a block 504B. Inclusion in the blockchain 502B of a transaction sending data to the smart contract may cause validating nodes to update a state database. As such, allowing network participants may access a rich state mechanism to manage the analysis of the weather data and/or parametric event data, and ultimately to detect a parametric event trigger, authenticate a parametric event, and/or calculate an assessment of risk.

Parametric smart contract state 506B may include pieces of data to identify and track the request. For example, a contract owner may select a unique ID for the assessment of risk calculation or parametric event trigger such that subsequent transactions and data sent to the smart contract can identify the assessment of risk calculation or parametric event trigger by ID number. The contract owner may also specify an identity of the weather unit 116 and identities of devices authorized to provide weather data for the parametric event, such as the weather unit 116 and/or the mobile device 112.

In at least one embodiment, the weather unit 116 and/or the mobile device 112 may be identifiable by cryptographic public keys assigned to the respective entities. Subsequent data sent to the smart contract may include a message signed by private keys corresponding to the public keys identifying the weather unit 116 and/or the mobile device 112 in the smart contract, thereby providing cryptographic proof that an authorized entity originated the transaction, such as an authorized weather unit 116 and/or an authorized mobile device 112.

The parties may solely manage the private and public keys to minimize the attack surface for any attackers that might attempt to forge a transaction (e.g., the parties generate public/private cryptographic key pairs offline and only provide the public key to other network participants). A party's private keys may be generated according to a securely stored seed value (e.g., on a piece of physical paper or multiple copies of a piece of paper) such that the private keys may be recovered in the case of a data loss.

To detect the parametric event trigger for the user, the smart contract state 506B may obtain trigger threshold information, such as weather data, historical data, particular parametric data, and/or other data as described herein, particularly as described with regard to FIG. 5A. In some embodiments, the data may be interpretations of raw sensor data or may be analyzed unstructured data, as described herein. The data may include weather data generated at a particular time interval or at several time intervals over a particular time period.

The weather unit 116 and/or the mobile device 112 may broadcast transactions that may include weather data and/or parametric event data to the blockchain 502B. An entity may cryptographically sign the evidence to provide cryptographic proof-of-identity that the evidence came from a weather unit 116 and/or mobile device 112 authorized to provide weather data and/or parametric event data. Accordingly, the smart contract may compare the provided identity to a list of weather units 116 and/or mobile devices 112 authorized to weather data and/or parametric event data.

Another aspect of the smart contract state 506B is the smart contract data. Smart contract data may be comparable to the private and public data in an object created according to an object-oriented programming paradigm in that the system may directly update smart contract data from outside the object, or the system may update the smart contract data only in limited ways, such as by calling a method of the smart contract. The smart contract data may include weather metrics and/or key information which the system may generate based upon the weather data and/or the parametric event, such as a threshold information, payment information, insurance policy, calculated customizable quote, and/or any other such data as described herein.

In some embodiments, the smart contract may generate the payment and/or payment information for the affected user(s) based upon the smart contract data. For example, the payment information may include weather data in accordance with the smart contract data. In some embodiments, the smart contract may transmit the generated payment and/or payment information to the payee device 114 or to an address on the blockchain 502B which is associated with the payee device 114.

For example, the smart contract data may note that, if user A is the only affected user, then each other member of the zero-trust index mutual aid pays an equivalent 33% of the damages. In other embodiments, each member of the zero-trust index mutual aid pays an equal share including the affected member (e.g., 25% each). In still other embodiments, the affected user A pays some predetermined amount or percentage and the remainder is allocated up between the unaffected users B, C, and D. It will be understood that these examples are not indicative of every potential division, and that other such divisions of damages may be implemented according to the smart contract as described herein.

It will be understood that the above disclosure is one example and does not necessarily describe every possible implementation. As such, it will be further understood that alternate embodiments may include fewer, alternate, and/or additional steps or elements.

### Exemplary Distributed Ledger Operations

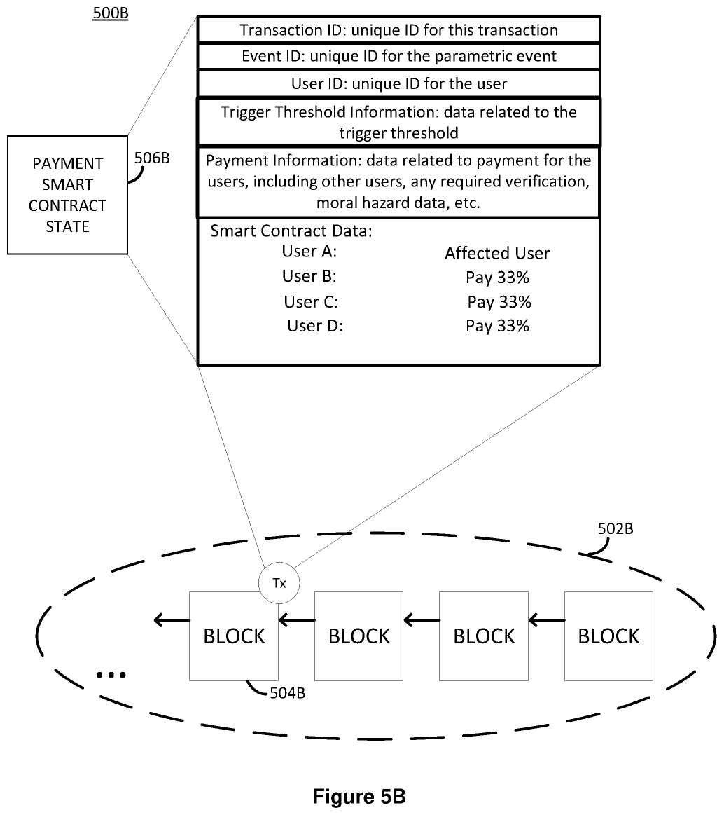

FIG. 6 is a flow diagram of an exemplary computer-implemented method 600 for generating and/or maintaining a zero-trust index mutual aid on a distributed ledger maintained by a plurality of participants. The method 600 may be implemented by one or more processors of a computing device such as weather unit 116 or mobile device 112. Alternatively or additionally, the method 600 may be implemented by one or more processors of a distributed system such as computing system 100 and/or various components of computing system 100 as described with regard to FIG. 1 above.

At block 602, the computing system 100 may receive weather data at the distributed ledger. Depending on the implementation, the computing system 100 may receive the weather data from a weather oracle, a synthetic aperture radar (SAR), a smart device, a weather database, a weather application, a website, a chatroom, a blog, storm chaser comments, a video/audio sharing platform, a sensor as described herein, and/or any other source as described herein. In some embodiments, the weather data is unstructured weather data and, as such, may need to be processed and/or otherwise analyzed by the computing system 100 before being used as described herein. For example, in some such embodiments, the computing system 100 analyzes the unstructured weather data using natural language processing (NLP) and/or otherwise normalizes the unstructured weather data before using the weather data for detecting a parametric event trigger, authenticating a parametric event, and/or calculating an assessment of risk.

In further embodiments, the computing system 100 may further receive other data related to a parametric event in question. For example, the computing system 100 may receive soil data, chemical data, broader environmental data, etc. As such, in some embodiments, the computing system 100 may further perform the steps as described herein using additional or alternative data from the weather data.

At block 604, the computing system 100 detects, based at least upon the weather data, that a trigger for a parametric event is met for a first subset of a plurality of users. Depending on the embodiment, the parametric event may be a particular weather event (e.g., a rainfall of greater than 2 inches in an hour, a hail storm, a tornado, high winds, heavy down pour, etc.), a general weather event (e.g., a spate of unseasonably cold weather for a week; prolonged drought, lack of rain during a certain time period (such as during July or August, or during pollination), etc.), a general status event (e.g., a failure of a field of crops, or below average yields for one or more fields), another type of parametric event (e.g., a chemical composition change in soil contents), etc. Similarly, depending on the embodiment, the trigger event may be a particular measurable threshold (e.g., 2 inches of rainfall in an hour or less, hail for 15 minutes, high winds for 20 minutes, etc.), a particular calculated threshold (e.g., a 50% chance of failure for a field, 20% estimated crop yield loss (such as due to lack of rain during and after pollination), an indicative flag (e.g., detecting that snow has fallen or a frost has occurred during the early or late growing season—damaging the crop, leading to crop loss, or ending the growing season prematurely), or any other similar trigger.

Depending on the embodiment, the trigger event may be unique to the user or the trigger event may be shared by multiple users in the zero-trust index mutual aid. In some embodiments, the user(s) sets the trigger event when joining the zero-trust index mutual aid. In further embodiments, the other users of the zero-trust index mutual aid approve the trigger event before the trigger event is set. In other embodiments, some users of the zero-trust index mutual aid may approve the trigger while others may opt out. In still further embodiments, a third-party maintaining the zero-trust index mutual aid, such as an insurance company or underwriter, may approve and/or set the trigger event, as well as may determine what other users provide coverage (i.e., insurance coverage, such as crop insurance coverage) for the user in case the trigger event is met. The particular details of the trigger event may be stored on the distributed ledger, may be included in any transactions related to the user and/or the parametric event, and/or may be stored in a smart contract detailing the user relation with the zero-trust index mutual aid.

In some embodiments, the computing system 100 may detect the trigger responsive to receiving weather data indicative of the trigger and/or a threshold of the trigger. For example, the computing system 100 may receive an indication from a weather oracle that 2 inches of rainfall has occurred in an area for a user. In further embodiments, the computing system 100 may analyze the received weather data to determine that a trigger is met for a parametric event. For example, the computing system 100 may receive data from a weather oracle suggesting a decline in temperature and data from a soil sensor suggesting that the soil is drying out. From the received data, the computing system 100 may determine that a trigger of a 50% chance of failure for a field is met, and may subsequently proceed to block 606.

Depending on the embodiment, the computing system 100 may detect the trigger using a trained machine learning algorithm, as described in more detail above with regard to FIG. 1. Further, the computing system 100 may train the machine learning algorithm using training data and/or real world data. In some such embodiments, the computing system 100 may receive an indication from a user or from a third-party maintaining the zero-trust index mutual aid whether the machine learning algorithm accurately detected that the trigger for the parametric event was met. Then, based upon the indication and the weather data used to make the determination, the computing system 100 may update (e.g., train) the machine learning algorithm. In some embodiments, the computing system 100 may train the machine learning algorithm by updating weight values assigned to types of data, modifying the techniques for analyzing unstructured data, changing the sources of data used, changing the weights of sources of data used, etc.

At block 606, the computing system 100 may retrieve, responsive to the detecting, payment from a second subset of the plurality of users in accordance with a smart contract stored on the distributed ledger. In some embodiments, the computing system 100 may specifically only retrieve the payment after detecting the trigger for the parametric event. As such, in some such embodiments, the zero-trust index mutual aid may not collect initial premiums from the users, but instead may retrieve the payment from the users bound by the smart contract when the event in question actually occurs.

In some embodiments, the smart contract may detail a particular list of users from whom the computing system 100 retrieves payment. In further embodiments, the smart contract details particular percentages or amounts from each such user that the respective user is responsible for. In other embodiments, the smart contract may not detail such information and the computing system 100 may retrieve the information from elsewhere on the distributed ledger. In still other embodiments, the computing system 100 may retrieve the payment based upon a default state unless informed otherwise by the smart contract. In some such embodiments, the default state is to retrieve payment equally from every non-affected user of the zero-trust index mutual aid. Depending on the embodiment, the computing system 100 may retrieve the payment after authenticating the parametric event, as described in more detail with regard to FIG. 7 below.

At block 608, the computing system 100 may allocate the payment from the second subset of the plurality of users into respective allocated payments in accordance with the smart contract. Similar to retrieving the payment, the computing system 100 may allocate the payment according to the smart contract as described in more detail above. In some such embodiments, the computing system 100 may allocate the payment according to particular details (e.g., user A has a policy to receive $5,000 and use B has a policy to receive $10,000). In further embodiments, the computing system 100 allocates the payment according to proportion of damages suffered.

At block 610, the computing system 100 may cause one or more devices associated with the first subset of the plurality of users to receive a notification of the respective allocated payments in accordance with the smart contract. In some embodiments, the affected user(s) may receive the payment in response to transmitting an acceptance of the payment in response to the notification. In further embodiments, the affected user(s) may automatically receive the payment as or alongside the notification. In still further embodiments, the affected user(s) may need to provide evidence of damages to a third-party maintaining the zero-trust index mutual aid and/or other users of the zero-trust index mutual aid before the computing system 100 releases the payment.

It will be understood that the above disclosure is one example and does not necessarily describe every possible implementation. As such, it will be further understood that alternate embodiments may include fewer, alternate, and/or additional steps or elements.

FIG. 7 is a flow diagram of an exemplary computer-implemented method 700 for authenticating a parametric event via a zero-trust index mutual aid on a distributed ledger maintained by a plurality of participants. The method 700 may be implemented by one or more processors of a computing device such as weather unit 116 or mobile device 112. Alternatively or additionally, the method 700 may be implemented by one or more processors of a distributed system such as computing system 100 and/or various components of computing system 100 as described with regard to FIG. 1 above.

At block 702, the computing system 100 may transmit details of a parametric event to at least some of a plurality of users. Depending on the embodiment, the computing system 100 may transmit the details responsive to detecting that the trigger has occurred in block 604 of FIG. 6, as described above. In some embodiments, the computing system 100 may additionally or alternatively transmit the details to a third-party responsible for maintaining the zero-trust index mutual aid and/or for performing a risk assessment. In some embodiments, the details of the parametric event may include the trigger, the weather data used to detect whether the trigger has been met, data regarding the smart contract and/or payment information, data regarding the damages, etc.

At block 704, the computing system 100 may receive an indication of whether a moral hazard is associated with the parametric event. Depending on the embodiment, a moral hazard may be an indication that a user is acting in bad faith. For example, a user trying to obtain coverage limits for their crops that are well in excess of regional market prices or the number of acres in production may be an indication of a bad faith attempt to defraud other users of the zero-trust index mutual aid. In some embodiments, the computing system 100 may note a moral hazard in response to a majority of the unaffected users indicating such, a majority of all users indicating such, a single user indicating such, all unaffected users indicating such, etc.

By providing the details of the parametric event to other users and/or allowing other users to note indications of moral hazards, the computing system 100 allows for greater transparency. Implementing the techniques described herein via a blockchain of the computing system 100 further improves the redundancy and security, generally allowing the computing system 100 to reduce the risk of fraud.

In some embodiments, the flow of method 700 continues to block 706 and/or block 708. In other embodiments, the flow of method 700 proceeds from block 704 directly to block 710. In still other embodiments, method 700 may separately implement blocks 702/704 and 706/708, and thus the flow may be substantially in parallel or separated (e.g., blocks 702/704/710 and blocks 706/708/710).

At block 706, the computing system 100 may transmit weather data (e.g., the weather data received in block 602 as described with regard to FIG. 6 above) to a third-party. In some embodiments, the third-party may be a party responsible for maintaining the zero-trust index mutual aid. In further embodiments, the third-party may additionally or alternatively be a party responsible for performing a risk assessment of the assessment of risk for a user. Depending on the embodiment, the third-party may be an insurance company, an underwriter, an analyst, etc. It will be understood that, although the third-party referred to as a third-party, the third-party may be part of the computing system 100 and/or part of the blockchain 118 of computing system 100. In some embodiments, the third-party may be or have access to a node of the blockchain 118, but is not bound by and/or covered by a smart contract. As such, the third-party may refer to a server or device that is part of the computing system 100.

At block 708, the computing system 100 may receive an assessment of risk for at least some of the plurality of users. In some embodiments, the assessment of risk may be for each user bound by a particular smart contract being analyzed. In further embodiments, the assessment of risk may be for each user of the zero-trust index mutual aid. In some embodiments, the third-party may generate the assessment of risk based upon the received weather data and/or the received parametric event details. For example, the third-party may determine, based upon the details of the parametric event and the weather data, that a user would have been at a 70% risk of loss.

In further embodiments, the third-party in the computing system 100 may determine the assessment of risk and assessment of risk using a smart contract. For example, the smart contract may receive weather data as described in FIG. 5B above and may generate an assessment of risk based upon the weather data. In some embodiments, the smart contract may transmit the generated assessment of risk to the parametric engine 180 or to an address on the blockchain which is associated with the parametric engine 180. In further embodiments, the computing system 100 may further calculate the assessment of risk based upon any of: a number of past incidents for the user, historical weather data, historical claims data, GPS and/or location data, other potential risk data, and/or any combination thereof. In still further embodiments, the third-party may make the determination using a machine learning algorithm as described above with regard to FIGS. 1 and 6.

At block 710, the computing system 100 may authenticate the parametric event based at least upon the indication of a moral hazard and/or the assessment of risk. In some embodiments, the computing system 100 may assign different weights to the indication of the moral hazard and/or the assessment of risk. For example, the computing system 100 may give more weight to the neutral assessment of risk, more weight to the informed opinions of the other users, more weight according to a scheme based upon a proportion of users agreeing about the moral hazard, etc. In further embodiments, the computing system 100 authenticates the parametric event using a machine learning algorithm that may be trained as described above with regard to FIGS. 1 and 6.

In some embodiments, the computing system 100 may perform the events of method 700 during the events of method 600. In some such embodiments, the computing system 100 may perform the events of methods 700 before retrieving payment at block 606. As such, the computing system 100 may retrieve the payment responsive to authenticating the parametric event at block 710.

### Additional Considerations

It will be understood that the above disclosure is one example and does not necessarily describe every possible implementation. As such, it will be further understood that alternate embodiments may include fewer, alternate, and/or additional steps or elements.

With the foregoing, a user may opt-in to a rewards, insurance discount, or other type of program. After the insurance customer provides their affirmative consent, an insurance provider remote server may collect data from the user's mobile device, vehicle, smart home, wearables, smart glasses, or other smart devices—such as with the customer's permission or affirmative consent. The data collected may be related to weather data, accident data, parametric event data, and/or insured assets before (and/or after) an insurance-related parametric event, including those events discussed elsewhere herein. In return, risk averse insureds, property owners, and/or individuals vulnerable to weather-related parametric events may receive discounts or insurance cost savings related to personal articles, property, and other types of insurance from the insurance provider.

In one aspect, weather data, parametric event data, accident data, and/or other data, including the types of data discussed elsewhere herein, may be collected or received by an insurance provider remote server, such as via direct or indirect wireless communication or data transmission from a weather unit, mobile device, or other user computing device, after a user affirmatively consents or otherwise opts-in to an insurance discount, reward, or other program. The insurance provider may then analyze the data received with the user's permission to provide benefits to the customer as described herein. As a result, risk averse customers may receive insurance discounts or other insurance cost savings based upon data that reflects low risk behavior and/or technology that mitigates or prevents risk to (i) insured assets, such as homes, personal belongings, or property, or (ii) users.

The following considerations also apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or

In addition, use of “a” or “an” is employed to describe elements and components of the embodiments herein. This is done merely for convenience and to give a general sense of the invention. This description should be read to include one or at least one and the singular also may include the plural unless it is obvious that it is meant otherwise.

Upon reading this disclosure, those of skill in the art will appreciate still additional alternative structural and functional designs for providing feedback to members of the zero-trust index mutual aid, through the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed:

1. A computer-implemented method for facilitating a zero-trust index mutual aid on a distributed ledger, the computer-implemented method comprising:
receiving, by one or more processors, weather data at the distributed ledger;
detecting, by the one or more processors and based at least upon the weather data, that a trigger for a parametric event is met for a first subset of a plurality of users;
retrieving, by the one or more processors and responsive to the detecting, payment from a second subset of the plurality of users in accordance with a smart contract stored on the distributed ledger;
allocating, by the one or more processors, the payment from the second subset of the plurality of users into respective allocated payments in accordance with the smart contract; and
causing, by the one or more processors, one or more devices associated with the first subset of the plurality of users to receive notifications of the respective allocated payments in accordance with the smart contract.

2. The computer-implemented method of claim 1, wherein the detecting includes detecting that the trigger for the parametric event is met using a machine learning algorithm, the method further comprising:
receiving an indication whether the machine learning algorithm accurately detected that the trigger for the parametric event is met; and
training the machine learning algorithm based upon at least the weather data and the indication.

3. The computer-implemented method of claim 1, further comprising:
transmitting, to the second subset of the plurality users, details of the parametric event;
receiving, from at least some of the second subset of the plurality users, an indication of whether a moral hazard is associated with the parametric event; and
authenticating, based at least upon the indication, the parametric event;
wherein the retrieving payment is responsive to the authenticating and the detecting.

4. The computer-implemented method of claim 3, wherein the indication of whether a moral hazard is associated with the parametric event includes a consensus from a majority of the second subset of the plurality of users.

5. The computer-implemented method of claim 3, further comprising:
transmitting the weather data to a third party; and
receiving, from the third party, an assessment of risk for each of the plurality users;
wherein the authenticating is further based at least upon the assessment of risk.

6. The computer-implemented method of claim 1, wherein the receiving the weather data further comprises receiving the weather data from at least one of: (i) a distributed weather oracle, (ii) a synthetic aperture radar, or (iii) user comment databases.

7. The computer-implemented method of claim 1, wherein the weather data includes unstructured weather data, further comprising:
extracting the unstructured weather data; and
analyzing the unstructured weather data using natural language processing (NLP).

8. A computing system for facilitating a zero-trust index mutual aid on a distributed ledger, the computing system comprising:
a memory storing a set of computer-executable instructions; and
one or more processors interfacing with the memory, and configured to execute the computer-executable instructions to cause the one or more processors to:
receive weather data at the distributed ledger,
detect, based at least upon the weather data, that a trigger for a parametric event is met for a first subset of a plurality of users,
retrieve, responsive to the detecting, payment from a second subset of the plurality of users in accordance with a smart contract stored on the distributed ledger,
allocate the payment from the second subset of the plurality of users into respective allocated payments in accordance with the smart contract, and
cause the first subset of the plurality of users to receive the respective allocated payments in accordance with the smart contract.

9. The computing system of claim 8, wherein the detecting includes detecting that the trigger for the parametric event is met using a machine learning algorithm and the memory further stores instructions that, when executed by the one or more processors, cause the computing system to:
receive an indication whether the machine learning algorithm accurately detected that the trigger for the parametric event is met; and
train the machine learning algorithm based upon at least the weather data and the indication.

10. The computing system of claim 8, wherein the memory further stores instructions that, when executed by the one or more processors, cause the computing system to:
transmit, to the second subset of the plurality users, details of the parametric event;
receive, from at least some of the second subset of the plurality users, an indication of whether a moral hazard is associated with the parametric event; and
authenticate, based at least upon the indication, the parametric event;
wherein the retrieving payment is responsive to the authenticating and the detecting.

11. The computing system of claim 10, wherein the indication of whether a moral hazard is associated with the parametric event includes a consensus from a majority of the second subset of the plurality of users.

12. The computing system of claim 10, wherein the memory further stores instructions that, when executed by the one or more processors, cause the computing system to:
transmit the weather data to a third party; and
receive, from the third party, an assessment of risk for each of the plurality users;
wherein the authenticating is further based at least upon the assessment of risk.

13. The computing system of claim 8, wherein the receiving the weather data further comprises receiving the weather data from at least one of: (i) a distributed weather oracle, (ii) a synthetic aperture radar, or (iii) user comment databases.

14. The computing system of claim 8, wherein the weather data includes unstructured weather data and the memory further stores instructions that, when executed by the one or more processors, cause the computing system to:
extract the unstructured weather data; and
analyze the unstructured weather data using natural language processing (NLP).

15. A tangible, non-transitory computer-readable medium storing instructions for facilitating a zero-trust index mutual aid on a distributed ledger that, when executed by one or more processors of a computing device, cause the computing device to:
receive weather data at the distributed ledger,
detect, based at least upon the weather data, that a trigger for a parametric event is met for a first subset of a plurality of users,
retrieve, responsive to the detecting, payment from a second subset of the plurality of users in accordance with a smart contract stored on the distributed ledger,
allocate the payment from the second subset of the plurality of users into respective allocated payments in accordance with the smart contract, and
cause the first subset of the plurality of users to receive the respective allocated payments in accordance with the smart contract.

16. The tangible, non-transitory computer-readable medium of claim 15, wherein the detecting includes detecting that the trigger for the parametric event is met using a machine learning algorithm and the non-transitory computer-readable medium further includes instructions that, when executed by the one or more processors, cause the computing device to:
receive an indication whether the machine learning algorithm accurately detected that the trigger for the parametric event is met; and
train the machine learning algorithm based upon at least the weather data and the indication.

17. The tangible, non-transitory computer-readable medium of claim 15, wherein the non-transitory computer-readable medium further includes instructions that, when executed by the one or more processors, cause the computing device to:
transmit, to the second subset of the plurality users, details of the parametric event;
receive, from at least some of the second subset of the plurality users, an indication of whether a moral hazard is associated with the parametric event; and
authenticate, based at least upon the indication, the parametric event;
wherein the retrieving payment is responsive to the authenticating and the detecting.

18. The tangible, non-transitory computer-readable of claim 17, wherein the indication of whether a moral hazard is associated with the parametric event includes a consensus from a majority of the second subset of the plurality of users.

19. The tangible, non-transitory computer-readable medium of claim 17, wherein the non-transitory computer-readable medium further includes instructions that, when executed by the one or more processors, cause the computing device to:
transmit the weather data to a third party; and
receive, from the third party, an assessment of risk for each of the plurality users;
wherein the authenticating is further based at least upon the assessment of risk.

20. The tangible, non-transitory computer-readable medium of claim 15, wherein the receiving the weather data further comprises receiving the weather data from at least one of: (i) a distributed weather oracle, (ii) a synthetic aperture radar, or (iii) user comment databases.
